(19) United States
(12) Patent Application Publication
(10) Pub. No.: US 2020/0309891 A1
(43) Pub. Date: Oct. 1, 2020

(54) Optimization For Angle Of Arrival And Angle Of Departure Detection

(71) Applicant: Silicon Laboratories Inc., Austin, TX (US)

(72) Inventors: Joel Kauppo, Espoo (FI); Sauli Johannes Lehtimaki, Nummela (FI); Antonio Torrini, Austin, TX (US)

(21) Appl. No.: 16/364,482

(22) Filed: Mar. 26, 2019

(51) Int. Cl. G01S 3/12; G01S 3/46; G06F 17/16; G06F 7/483

(52) U.S. Cl. CPC G01S 3/12; G06F 7/483; G06F 17/16; G01S 3/46

(57) ABSTRACT

An optimized system and method for determining an angle of arrival or angle of departure is disclosed. A coarse pre-search is performed to identify the general location of the incoming signal. Based on this information, a high-resolution search is performed at the general location identified in the coarse pre-search. This multi-stage approach significantly reduces the number of computations that must be performed by the device, and also reduces the amount of memory that is required to store the results of the computations. For example, a full scan may require the computations to be performed over 32,000 times. Through use of this approach, the number of computations may be reduced by over 97%. This is a similar reduction in computation time and in the amount of memory consumed by this method.

### FIELD

This disclosure describes systems and methods for optimization for the computation of the angle of arrival of an incoming signal for all angle of arrival estimation algorithms that utilize a one- or two-dimensional search in the angular domain, and specifically, minimizing the memory consumption and computational complexity associated with making this determination.

### BACKGROUND

Algorithms for determining the angle of arrival or angle of departure, collectively referred to as AoX, of an incoming wireless signal are well known. These algorithms exploit the difference in phase of the incoming signal at a plurality of antenna elements. For example, a linear antenna array can be formed, where the spacing between adjacent antenna elements is constant. As the incoming signal is received, it will reach the antenna element located closest to the transmitter first. The incoming signal will then reach the other antenna elements in the antenna array based on their distance to the transmitter.

Using the difference in phase, the direction of the transmitter can be estimated. Direction of arrival is important in various applications, such as beacon location, or spatial positioning.

However, existing angular-domain search-based algorithms have limitations. For example, these algorithms are computationally intensive and require large amounts of memory, if the pseudo-spectrum is to be saved. For example, a two-dimensional AoX algorithm may scan 360° in the azimuth direction and 90° , or theoretically even 180° in the elevation direction. Thus, the algorithm will perform the AoX computation 360×90 times, or 32,400 times. Similarly, the result of each of these computations may be saved. This requires 32.4 kB of memory, assuming 8-bit calculations, or 129.6 kB if floating point computations are performed. However, many new devices that are employed as part of the Internet of Things (IoT) simply do not have the computational power or memory capacity to perform these operations. Consequently, an improved system and method that provides AoX information without requiring the amount of memory and the number of computations traditionally needed would be beneficial. Further, it would be advantageous if this system and method did not sacrifice accuracy to attain these results.

### SUMMARY

An optimized system and method for determining an angle of arrival or angle of departure is disclosed. A coarse pre-search is performed to identify the general location of the incoming signal. Based on this information, a high resolution search is performed at the general location identified in the coarse pre-search. This multi-stage approach significantly reduces the number of computations that must be performed by the device, and also reduces the amount of memory that is required to store the results of the computations. For example, a full scan may require the computations to be performed over 32,000 times. Through use of this approach, the number of computations may be reduced by over 97%. This is a similar reduction in computation time and in the amount of memory consumed by this method.

According to one embodiment, a method of reducing the number of computations needed to perform an angle of arrival or an angle of departure algorithm is disclosed. The method comprises executing a coarse pre-search, which comprises performing an angle of arrival or angle of departure algorithm at a low resolution, over a first range of azimuth and elevation angles; identifying a highest peak from the coarse pre-search; executing a search, which comprises performing the angle of arrival or angle of departure algorithm at a high resolution over a scan region selected based on the highest peak, where the scan region is defined by a second range of azimuth and elevation angles, wherein the second range is smaller than the first range; and determining the angle of arrival or angle of departure based on the results of the search. In some embodiments, the low resolution is 5° or more. In other embodiments, the low resolution is 10° or more. In certain embodiments, the second range comprises 20° in the azimuth and elevation directions. In certain embodiments, the coarse pre-search is executed a plurality of times to obtain a coarse matrix, wherein the highest peak is determined based on the coarse matrix. In certain embodiments, the search is executed a plurality of times to obtain the angle of arrival or angle of departure. In some embodiments, a second pre-search is executed after executing the coarse pre-search and before executing the search, wherein the second pre-search uses a higher resolution than the coarse pre-search and is performed over a third range, less than the first range and greater than the second range. In some embodiments, the angle of arrival or angle of departure is used to perform wayfinding or spatial positioning.

According to another embodiment, a locator device is disclosed. The locator device comprises an antenna array, arranged as a one- or two-dimensional array; a wireless receiver in communication with the antenna array; a processing unit; and a memory device in communication with the processing unit, comprising instructions, which when executed by the processing unit, enable the locator device to: execute a coarse pre-search, which comprises performing an angle of arrival or angle of departure algorithm at a low resolution, over a first range of azimuth and elevation angles to create a coarse matrix; identify a highest peak from the coarse matrix; execute a search, which comprises performing the angle of arrival or angle of departure algorithm at a high resolution over a scan region selected based on the highest peak, to create a result matrix, where the scan region is defined by a second range of azimuth and elevation angles, wherein the second range is smaller than the first range; and determine the angle of arrival or angle of departure based on the result matrix. In certain embodiments, the memory device further comprises instructions, which when executed by the processing unit, enable the locator device to: execute the coarse pre-search a plurality of times to obtain the coarse matrix. In certain embodiments, the memory device further comprises instructions, which when executed by the processing unit, enable the locator device to: execute the search a plurality of times to obtain the result matrix. In some embodiments, the memory device further comprises instructions, which when executed by the processing unit, enable the locator device to: execute a second pre-search after executing the coarse pre-search and before executing the search, wherein the second pre-search uses a higher resolution than the coarse pre-search and is performed over a third range, less than the first range and greater than the second range. In some embodiments, the low resolution is 5° or more. In certain embodiments, an amount of memory required to store the coarse matrix and the result matrix is less than 10 kB.

According to another embodiment, a device is disclosed. The device comprises an antenna; a wireless receiver in communication with the antenna; a processing unit; and a memory device in communication with the processing unit, comprising instructions, which when executed by the processing unit, enable the device to: execute a coarse pre-search, which comprises performing an angle of arrival or angle of departure algorithm at a low resolution, over a first range of azimuth and elevation angles to create a coarse matrix; identify a highest peak from the coarse matrix; execute a search, which comprises performing the angle of arrival or angle of departure algorithm at a high resolution over a scan region selected based on the highest peak, to create a result matrix, where the scan region is defined by a second range of azimuth and elevation angles, wherein the second range is smaller than the first range; and determine the angle of arrival or angle of departure based on the result matrix. In some embodiments, the device comprises an indicator to inform an operator of the angle of departure. In some embodiments, the device comprises an indicator to inform an operator of its spatial position. In some embodiments, the low resolution is 5° or more.

### BRIEF DESCRIPTION OF THE DRAWINGS

For a better understanding of the present disclosure, reference is made to the accompanying drawings, in which like elements are referenced with like numerals, and in which:

FIG. 1 is a block diagram of a representative locator device that may estimate angle of arrival according to one embodiment;

FIG. 2 shows a network having a locator device and at least one transmitter according to one embodiment;

FIG. 3 shows a network having a beacon and a device according to one embodiment;

FIG. 4 shows a two-dimensional pseudo-spectrum;

FIG. 5 shows a sequence to determine the angle of arrival or departure according to one embodiment;

FIG. 6 shows the pseudo-spectrum generated by the coarse pre-search; and

FIG. 7 shows the pseudo-spectrum created by the high resolution search around the identified location.

### DETAILED DESCRIPTION

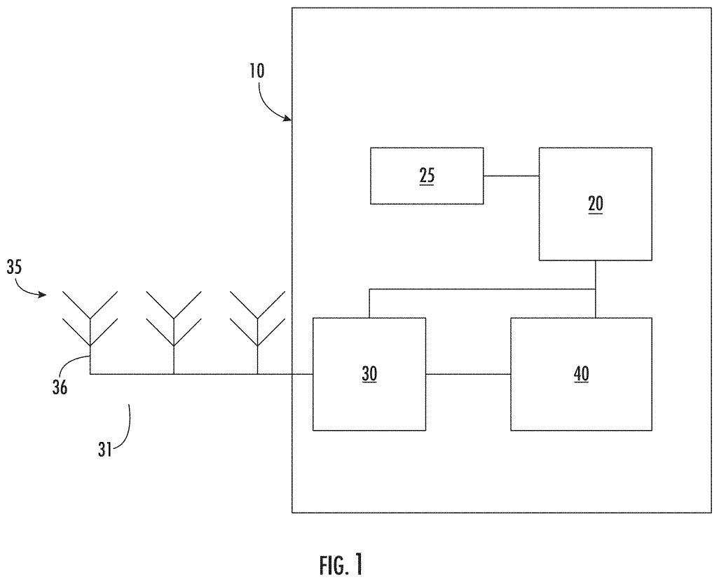

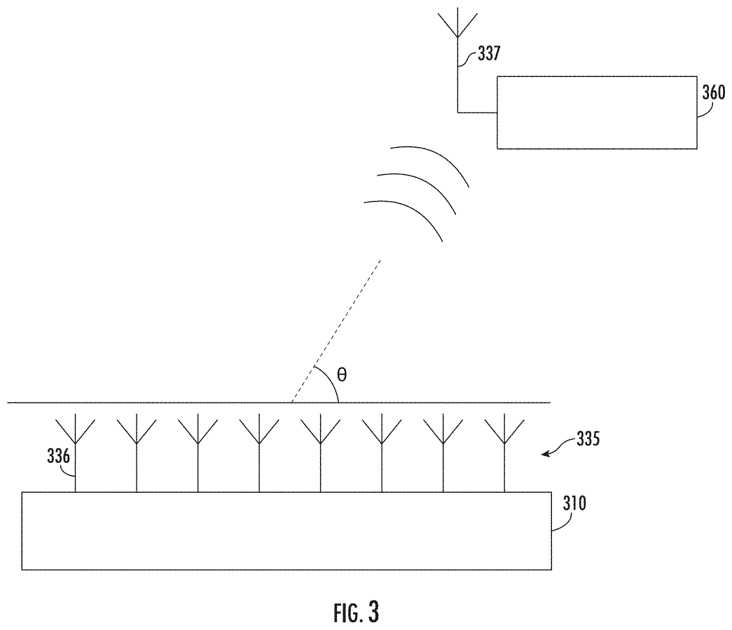

FIG. 1 shows a block diagram of a representative network device. This network device may serve as a locator device 10, as described in more detail below. This network device may also be used to determine angle of departure, as shown in FIG. 3.

The locator device 10 has a processing unit 20 and an associated memory device 25. The processing unit 20 may be any suitable component, such as a microprocessor, embedded processor, an application specific circuit, a programmable circuit, a microcontroller, or another similar device. This memory device 25 contains the instructions, which, when executed by the processing unit 20, enable the locator device 10 to perform the functions described herein. This memory device 25 may be a non-volatile memory, such as a FLASH ROM, an electrically erasable ROM or other suitable devices. In other embodiments, the memory device 25 may be a volatile memory, such as a RAM or DRAM.

The locator device 10 also includes a network interface 30, which may be a wireless interface including an antenna array 35.

The antenna array 35 comprises a plurality of antenna elements 36, which are arranged in a fixed, known pattern. For example, in one embodiment, the antenna array 35 may comprise a plurality of antenna elements 36 arranged in a linear fashion. In one embodiment, the same spacing is established between any two adjacent antenna elements 36. In another embodiment, the antenna elements 36 may be arranged as a two-dimensional array or a three-dimensional array. In one further embodiment, the spacing between any two adjacent antenna elements 36 in one direction is the same. In certain embodiments, the spacing between antenna elements 36 is related to the transmitted and received wavelengths. For example, the spacing between adjacent antenna elements 36 may be a half wavelength or less. The number of antenna elements 36 in the antenna array 35 is not limited by this disclosure. Further, the type of antenna array is not limited, and may be, for example, a uniform linear array (ULA), a uniform rectangular array (URA), a uniform circular array (UCA) or any other type.

The wireless signals first enter the network interface 30 through antenna array 35. The antenna array 35 is in electrical communication with a low noise amplifier (LNA). In certain embodiments, an analog switch may be used to select one of the antenna elements 36 to communicate with the LNA. The LNA receives a very weak signal from one antenna element 36 in the antenna array 35 and amplifies that signal while maintaining the signal-to-noise ratio (SNR) of the incoming signal. The amplified signal is then passed to a mixer. The mixer is also in communication with a local oscillator, which provides two phases to the mixer. The cosine of the frequency may be referred to as Iₒ, while the sine of the frequency may be referred to as Qₒ. The Iₒ signal is then multiplied by the incoming signal to create the inphase signal, Iₘ. The Qₒ signal is then multiplied by a 90° delayed version of the incoming signal to create the quadrature signal, Qₘ. The inphase signal, Iₘ, and the quadrature signal, Qₘ, from the mixer are then fed into programmable gain amplifier (PGA). The PGA amplifies the Iₘ and Qₘ signals by a programmable amount. These amplified signals may be referred to as I_{g} and Q_{g}. The amplified signals, I_{g} and Q_{g}, are then fed from the PGA into an analog to digital converter (ADC). The ADC converts these analog signals to digital signals, I_{d} and Q_{d}. These digital signals may then pass through a channel filter. The filtered signals are referred to as I and Q. These I and Q signals can be used to recreate the amplitude and phase of the original signal. An analog switch may then be switched so as to select a different one of the antenna elements 36 so that the above process may be repeated for each antenna element 36. In certain embodiments, rather than utilizing an analog switch, the network interface may comprise a plurality of LNAs, mixers, PGAs and ADCs, so that the signals from all of the antenna elements 36 can be processed simultaneously.

The network interface 30 may support any wireless network, such as Bluetooth, Wi-Fi, networks utilizing the IEEE 802.15.4 specification, such as Zigbee, networks utilizing the IEEE 802.15.6 specification, and wireless smart home protocols, such as Z-Wave. The network interface 30 is used to allow the locator device to communicate with other devices disposed on the network 31.

The locator device 10 may include a second memory device 40 in which data that is received and transmitted by the network interface 30 is stored. This second memory device 40 is traditionally a volatile memory. The processing unit 20 has the ability to read and write the second memory device 40 so as to communicate with the other nodes in the network 31. Although not shown, the locator device 10 also has a power supply, which may be a battery or a connection to a permanent power source, such as a wall outlet.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions may be written in any programming language and is not limited by this disclosure. Thus, in some embodiments, there may be multiple computer readable media that contain the instructions described herein. The first computer readable media may be in communication with the processing unit 20, as shown in FIG. 1. The second computer readable media may be a CDROM, or a different memory device, which is located remote from the locator device 10. The instructions contained on this second computer readable media may be downloaded onto the memory device 25 to allow execution of the instructions by the locator device 10.

While the processing unit 20, the memory device 25, the network interface 30, and the second memory device 40 are shown in FIG. 1 as separate components, it is understood that some or all of these components may be integrated into a single electronic component. Rather, FIG. 1 is used to illustrate the functionality of the locator device 10, not its physical configuration.

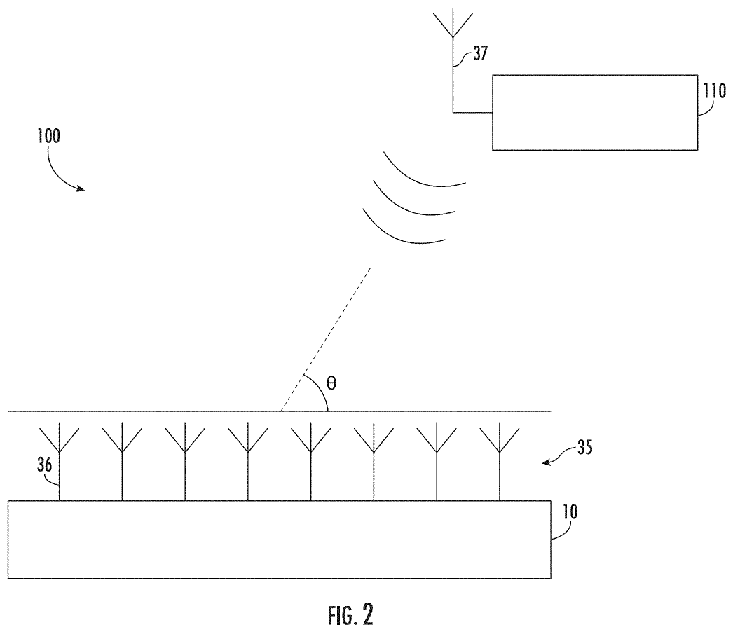

FIG. 2 shows a network 100 having at least one transmitter 110 and a locator device 10. In certain embodiments, the transmitter 110 may be a network device and contain many of the components described above and shown in FIG. 1. However, the transmitter 110 may not have an antenna array. Rather, the transmitter 110 may utilize a single antenna element 37. Further, the transmitter 110 may have a smaller amount of memory and may have less computational ability.

In FIG. 2, the transmitter 110 may be transmitting a signal toward the locator device 10. This signal may be referred to as a beacon. In certain embodiments, this beacon is transmitted using a network protocol, such as Zigbee or Bluetooth. In certain embodiments, the transmitter 110 issues a plurality of beacons at a plurality of different frequencies. The transmitter 110 may be offset from the locator device 10 in the azimuth and/or elevation directions. In this particular embodiment, the transmitter 110 is shown as being offset in the azimuth direction. Because of this offset, the signal from the transmitter 110 will reach the antenna elements 36 on the right side of the locator device 10 before it reaches the antenna elements 36 on the left side of the locator device 10. This difference in phase can be used to determine the direction of arrival, shown as θ in FIG. 2.

More specifically, the locator device 10 may utilize the I and Q signals described above to determine the amplitude and phase of the signal arriving at each of the antenna elements 36.

Furthermore, as noted above, this technique may be used to optimize the computation of angle of departure. In this scenario, the device roles are reversed and, referring to FIG. 3, the beacon 310 includes an antenna array 335, while the device 360 has a single antenna 337. The beacon 310 transmits a signal and the device 360 receives the signal. In this embodiment, the device 360 knows the geometry of the antenna array 335, switching sequence and switching timings for the beacon 310. Based on that information, the device 360 knows which IQ-data sample and which element 336 of the antenna array 335 are associated with one another. The antenna array geometry sent by the beacon 310 is needed by the device 360 for the angle estimation algorithm, which resides on the device 360 or on some processing unit in communication with the device 360.

Many angular-domain search-based algorithms are known that compute the direction of arrival and angle of departure based on the phase information obtained from an antenna array.

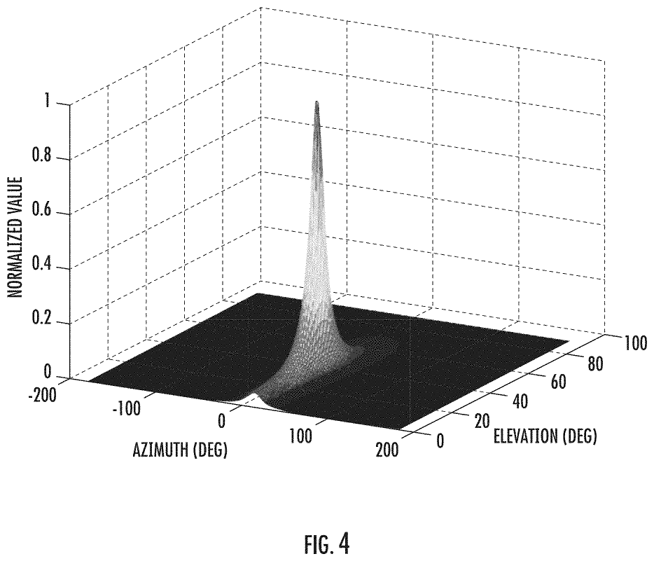

For example, the multiple signal classification (MUSIC) algorithm utilizes phase information to determine the direction of arrival. The MUSIC algorithm creates a one- or two-dimensional graph, depending on the configuration of the antenna array, where each peak on the graph represents a direction of arrival for an incoming signal. This one- or two-dimensional graph may be referred to as a pseudo-spectrum. The MUSIC algorithm calculates a value for each point on the graph. The computations required to obtain a single value are referred to as AoX calculations throughout this disclosure. To more clearly define these points, the MUSIC algorithm actually plots the reciprocal of these calculated values, so that the minimum value of the calculated values creates a narrow peak. Thus, the minimum value of any point in the pseudo-spectrum is 0, and there is no maximum value. Stated differently, a peak in the pseudo-spectrum corresponds to the angle of some signal entering the antenna array 35. FIG. 4 shows a graph of a typical two-dimensional pseudo-spectrum created using this approach.

As noted above, creating a full pseudo-spectrum, in two dimensions, typically requires AoX calculations to be performed at each combination of azimuth and elevation angle. In the case of a typical two-dimensional scan with 1 degree resolution, this is 360 azimuth angles and 90 elevation angles, which result in 32,400 AoX calculations. Further, the result of each of these calculations must be stored in memory, which consumes 32.4kB or 129.6 kB if floating point precision is used.

The present system and method reduces the number of AoX calculations that must be performed, and the amount of memory that must be allocated to storing the results of these calculations.

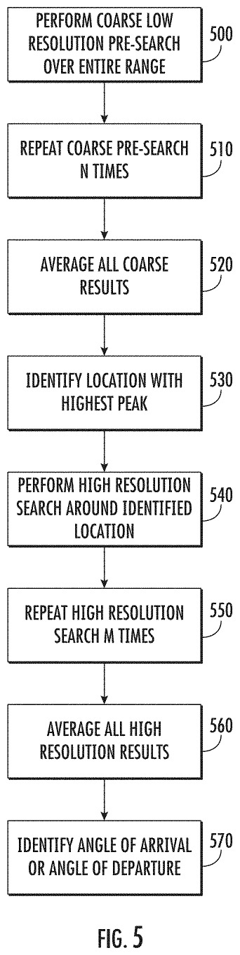

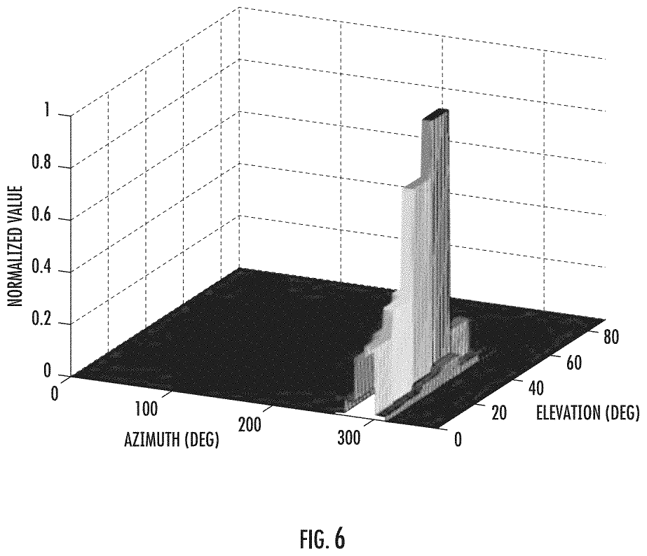

This method, which may be executed by the processing unit 20 based on instructions stored in memory device 25, employs a progressive approach. One embodiment is shown in FIG. 5. First, a coarse, low-resolution pre-search is performed, as shown in Process 500. This low-resolution pre-search is performed over a first range of azimuth and elevation angles. For example, the first range may be 360° of azimuth and 90° of elevation. This low-resolution pre-search may be performed, for example, at each 10° angle interval in each direction. In other words, the pre-search would perform calculations at azimuth angles of 0°, 10°, 20°, . . . 360°, and elevation angles of 0°, 10°, 20°, . . . 90°. Thus, for a full two-dimension low-resolution pre-search, a combination of 37 azimuth angles and 10 elevation angles may be evaluated. In other words, the pre-search performs the AoX algorithm, but rather than executing this algorithm at every angle in azimuth and elevation, execution is performed at much fewer angles. Thus, the pre-search performs the AoX algorithm, such as the MUSIC algorithm, at a lower angular resolution. Thus, 370 AoX calculations must be made and the memory must store 370 bytes using 8-bit data, or 1.48 kB, if floating point precision is used. This low-resolution pre-search will result in a pseudo-spectrum, such as that shown in FIG. 6. These calculations may be stored in a two-dimensional array, referred to as the Coarse Matrix. Thus, in this illustrative embodiment, the Coarse Matrix has a size of 37×10.

Next, as shown in Process 510, this coarse search may be repeated N times, where N is any positive integer. In one embodiment, each newly calculated value is added to the respective value of the Coarse Matrix. In other words,

$$Coarse\_Matrix [ i , j ] = {\sum }_{k = 1}^{N} P {S}_{k} [ i , j ]$$

for min azimuth angle≤i≤max_azimuth_angle and min_elevation_angle≤j≤max_elevation_angle.

In another embodiment, each newly calculated value is multiplied by the respective value in the Coarse Matrix. In other words,

$$Coarse\_Matrix [ i , j ] = {\sum }_{k = 1}^{N} P {S}_{k} [ i , j ]$$

for min_azimuth_angle≤i≤max_azimuth_angle and min_elevation_angle≤j≤max_elevation_angle.

After this coarse pre-search has been repeated N times, the values in the Coarse Matrix may be averaged, as shown in Process 520. In certain embodiments, where the Coarse Matrix is constructed by adding values from the pseudo-spectrums, the average is created by simply dividing all values in the Coarse Matrix by N+1. In certain embodiments, where the Coarse Matrix is constructed by multiplying values from the pseudo-spectrums, the average is created by taking the (N+1)^{th} root of each value in the Coarse Matrix. In yet other embodiments, no averaging is necessary as the goal of the coarse pre-search is to identify the peaks in the pseudo-spectrum. In other words, the summation or multiplication of the various pseudo-spectrums is sufficient to determine the highest peaks, and averaging is not necessary. Specifically, FIG. 6 shows that the vertical axis represents normalized value; however in other embodiments, the values on the vertical axis may be greater than 1.

In certain embodiments, Processes 510, 520 may be eliminated. For example, the coarse low-resolution pre-search may be performed only once. In this embodiment, the method proceeds from Process 500 directly to Process 530.

Next, as shown in Process 530, the location with the highest peak is identified. This is typically the largest value in the Coarse Matrix. The azimuth and elevation angles associated with this highest peak are recorded. At this point, the Coarse Matrix can be erased, freeing up this space in memory.

In another embodiment, where averaging is not performed, all of the values that are calculated during the coarse pre-search are not stored in a Coarse Matrix. Rather, the system simply retains the azimuth and elevation angles associated with the highest value. This is the highest peak that is used in Process 540.

Using the location identified in Process 530, a high resolution search can be performed, as shown in Process 540. In certain embodiments, the high resolution search scans a smaller scan region, such as a second range comprising 20° in the azimuth direction and 20° in the elevation direction. This search is done at higher resolution, such as 1° in each direction. The same AoX algorithm is used as was used in the pre-search; only the resolution and the range of angles in azimuth and elevation is changed.

In certain embodiments, the location identified in the Coarse Matrix as having the highest peak is set as the center of this scan region. For example, if the highest peak in the Coarse Matrix was located at (170°, 40°), the search may be performed on every azimuth angle and elevation angle combination in which the azimuth angle is between 160° and 180° and the elevation angle is between 30° and 50°.

However, other embodiments are also possible, for example, if there are two adjacent locations in the Coarse Matrix with the same or substantially similar values, the midpoint between these two locations may serve as the center of the scan region.

By choosing a scan region that is greater than the interval used in the pre-search, the probability of not identifying the correct peak is minimized. In other words, in the present example, the interval used in the pre-search was 10° in each direction, while the scan region encompasses 20° in each direction. This will result in a final matrix, referred to as Result Matrix, having a size of 20×20, which is approximately the same size as the Coarse Matrix. In this way, the amount of memory that is required by the algorithm is minimized.

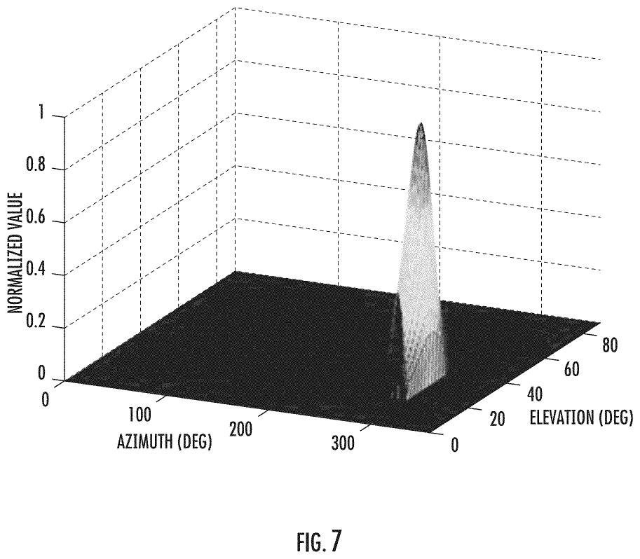

The high resolution search will create a pseudo-spectrum, such as that shown in FIG. 7. While the entire pseudo-spectrum is shown, note that calculations were only performed for the range of angles indicated by the coarse, low-resolution pre-search. The other positions are assumed to be 0.

Similar to the coarse search, an averaging algorithm may also be employed. As shown in Process 550, the high resolution search may be repeated M times, where the results of each scan are accumulated in the Result Matrix, as described above. The results from each scan may be added to or multiplied by the corresponding element in the Result Matrix.

As explained, the aggregated values in the Result Matrix may be averaged, as shown in Process 560. In certain embodiments, where the Result Matrix is constructed by adding values from the pseudo-spectrums, the average is created by simply dividing all values in the Result Matrix by N+1. In certain embodiments, where the Result Matrix is constructed by multiplying values from the pseudo-spectrums, the average is created by taking the (N+1)^{th} root of each value in the Result Matrix. In yet other embodiments, no averaging is necessary.

The highest peak in the Result Matrix is identified as the Angle of Arrival or Angle of Departure, as shown in Process 570.

In another embodiment, where averaging is not performed, all of the values that are calculated during the search are not stored in a Result Matrix. Rather, the system simply retains the azimuth and elevation angles associated with the highest value. This is the Angle of Arrival or Angle of Departure that is used in Process 570.

Note that this method produced a Coarse Matrix, which was of size 37×10. Consequently, this required 370 AoX calculations and consumed either 370 bytes or 1.48 Kbytes of memory, if floating point precision is used. The results of the Coarse Matrix were used to generate the Result Matrix, which was of size 20×20. Consequently, this high resolution step required 400 AoX calculations and consumed either 400 bytes or 1.6 kBytes of memory, if floating point precision is used. Thus, a total of 770 AoX calculations were performed and 400 bytes or 1.6 kBytes of memory were consumed. In fact, even if the Coarse Matrix is not deleted, the total is still less than 5 kB, if floating point precision is used.

In contrast, a traditional AoX algorithm performs 360×90=32,400 AoX calculations, and consumes either 32.4 kBytes or 129.6 kBytes of memory, if floating point precision is used. In other words, the present system performs only 2.3% of the AoX calculations that are typically performed. Additionally, the present system consumes 1.23% of the memory required by traditional AoX algorithms.

This dramatic reduction in number of calculations and memory space has important ramifications. First, number of calculations performed by the processing unit 20 has a tremendous impact on the amount of power consumed by the device. A 97.7% reduction in the AoX calculations will result in a significant power saving. This is especially important in smaller devices, which may be battery powered. Similarly, in these smaller devices, the amount of memory may be limited. By reducing the amount of memory needed for the AoX process, smaller devices that have a limited amount of memory are still able to perform the AoX algorithm. Also, the time required to compute this lower number of angle estimates is similarly drastically reduced. The optimization enables real-time direction finding even on smaller devices with less processing power.

While this disclosure describes use of the MUSIC algorithm, other angular-domain search-based algorithms may also be used. For example, the Minimum Variance Distortionless Response (MVDR) beamformer algorithm (also referred to as Capon's beamformer), the Bartlett beamformer algorithm, and variations of the MUSIC algorithm may also be used. In each of these, the algorithms use different mathematical formulas to calculate the spectrum, but each calculates a spectrum which can be used in the present disclosure.

The disclosure described the use of a low resolution pre-search, where the resolution was defined as 10° in both the azimuth and elevation directions. However, if desired, the resolution may be different in the azimuth and elevation directions. For example, the azimuth resolution may be 5°, while the elevation resolution is 10°.

Furthermore, although FIG. 5 shows a coarse pre-search followed by a high resolution search, other embodiments are also possible. For example, there may be a plurality of pre-searches, each with higher resolution. In one embodiment, a first pre-search may be performed over 360° of azimuth and 90° of elevation at 10° resolution. Based on the results, a second pre-search, with higher resolution may be performed over a subset of this range. For example, at 5° resolution, a range that covers 180° of azimuth and 45° of elevation may be performed, as this requires the same memory space as the first pre-search. Alternatively, a second pre-search having 2.5° resolution may be performed over a range that covers 90° of azimuth and 22.5° of elevation. Of course, other resolutions may be used for the second pre-search. Further, the number of pre-searches is not limited by this disclosure. These additional pre-searches would be performed after Process 530 in FIG. 5 and before Process 540.

Specifically, the second pre-search would use the highest peak identified from the coarse pre-search. The Coarse Matrix can be then erased. The second pre-search then performs an intermediate resolution search. This second pre-search scans a smaller scan region than the coarse low-resolution pre-search. In certain embodiments, the location identified in the Coarse Matrix as having the highest peak is set as the center of this scan region. The second pre-search can then repeat the process that was previously performed by the coarse pre-search in Processes 500-530, over a smaller scan region with higher resolution. The highest peak identified by the second pre-search can then be used by the high-resolution search in Process 540.

Further, although described above as having 360° of azimuth and 90° of elevation, the pseudo-spectrum does not have to span the entirety of the range. For example, rather than including 360° of azimuth angles, the pseudo-spectrum may cover only a portion of the azimuth range. Similarly, the entire range of elevation angles does not need to be spanned for a two-dimensional pseudo-spectrum. Thus, the term “pseudo-spectrum” denotes any spectrum generated by a direction of arrival or direction of departure algorithm, and does not require that the entire range of azimuth and elevation angles be included in the pseudo-spectrum.

Additionally, the disclosure above describes a coarse low-resolution pre-search that using 10° resolution, while the high-resolution scan uses 1° resolution. However, other embodiments are also possible. For example, the resolution used by the pre-search may be greater than or less than 10°. Higher resolution may yield more accurate pre-search results; however, the higher resolution will also consume more memory and computation time. For example, the pre-search may be performed using a resolution of 7.5°. This will create 48 azimuth angles (360/7.5) and 12 elevation angles (90/7.5). Thus, in this embodiment, the Coarse Matrix may have a size of 48×12. This would require 576 AoX calculations and consume 576 Bytes, or 2.304 kB if floating point precision is used. If the pre-search is performed using a resolution of 5°, the Coarse Matrix may have a size of 72×18. This would require 1296 AoX calculations and consume 1296 Bytes, or 5.184 kB, if floating point is used. Thus, by using of this method, the amount of memory that is utilized by the angle of arrival algorithm may be less than 10 kB, even when floating point precision is used.

The angle of arrival or departure may be used for many functions. For example, one angle of arrival locator can be used to locate a beacon. This class of applications may be referred to as wayfinding. For example, the beacon may be a set of car keys or another device that a user needs to find. A user, holding the locator device, may be led to the beacon based on the angle of arrival detected by the locator device. As an example, an automobile may be equipped with Bluetooth. A command may be sent by the owner to the automobile disposed in a parking lot to transmit a beacon or sequence of beacons. The locator device, which is carried by the owner, detects the angle of arrival and can lead the owner toward the automobile in the parking lot. In another embodiments, a shopping mall may install beacons at certain locations, such as near exits, certain stores, or the food court. The shopper may use these beacons to guide their way through the mall using a portable locator device. Similarly, the angle of arrival can be used to guide an operator toward an asset in a warehouse or other structure. The locator device may include an indicator that allows the operator to determine the angle of arrival. For example, the locator device may have a visual display that indicates the direction of the beacon. Alternatively, the locator device may have an audio output that informs the user of the direction of the beacon.

When multiple locators are used, the exact location of the transmitter can be determined. This class of applications is referred to as spatial positioning. For example, inside a structure that has multiple locator devices, the exact location of any transmitter may be determined. This may serve to replace GPS in these environments, as GPS positioning requires more power to execute and often does not function accurately in indoor environments. In one example, an operator may carry a mobile telephone. A plurality of locator devices each determine the angle of arrival for a beacon transmitted by this phone. In one embodiment, these angles of arrival are forwarded to the mobile phone. In another embodiment, these angles of arrival are forwarded to a centralized computational device, which calculates the position of the mobile phone based on all of the received angles of arrival. Thus, the angle of arrival from each locator device may be used by the mobile phone or another device to pinpoint the specific location of the mobile phone. If a plurality of locator devices are employed, three dimensional spatial positioning may also be possible.

Similar functions can be performed using an angle of departure algorithm. For example, as shown in FIG. 3, the user may have a device 360 that has a single antenna 337, rather than an antenna array. If the beacons 310, such as those described above in the shopping mall or warehouse, utilize an antenna array 335, the user's device 360 may determine the angle of departure.

The device 360 may also be able to determine the angle of departure from multiple beacons 310. If the position of the beacons 310 is known, the device 360 may be able to calculate its spatial position from these angles of departure.

In other words, this information can be used in the same manner as angle of arrival information for wayfinding and spatial positioning. Furthermore, the device 360 may have an indicator to provide an indication of the angle of departure to the user. In other embodiments, the device 360 may have an indicator to inform the user of its spatial position.

Thus, in one embodiment, the present disclosure describes a network device, such as that shown in FIG. 1, where less than 6 kB of memory are consumed by storing the results of the AoX algorithm. In certain embodiments, less than 4 kB of memory are consumed by storing the results of the AoX algorithm. In certain embodiments, less than 2 kB are consumed by storing the results of the AoX algorithm.

The present system has many advantages. As described above, the present system and method allow for the accurate calculation of the angle of arrival while using only a small fraction of the memory and computational power that is typically required. This allows devices that are battery powered to perform the AoX algorithm without exhausting the battery. Similarly, this feature allows devices that have limited amounts of memory to perform the AoX algorithm.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of reducing the number of computations needed to perform an angle of arrival or an angle of departure algorithm, comprising:
executing a coarse pre-search, which comprises performing an angle of arrival or angle of departure algorithm at a low resolution, over a first range of azimuth and elevation angles;
identifying a highest peak from the coarse pre-search;
executing a search, which comprises performing the angle of arrival or angle of departure algorithm at a high resolution over a scan region selected based on the highest peak, where the scan region is defined by a second range of azimuth and elevation angles, wherein the second range is smaller than the first range; and
determining the angle of arrival or angle of departure based on results of the search.

2. The method of claim 1, wherein the low resolution is 5° or more.

3. The method of claim 2, wherein the low resolution is 10° or more.

4. The method of claim 1 wherein the second range comprises 20° in the azimuth and elevation directions.

5. The method of claim 1, further comprising executing the coarse pre-search a plurality of times to obtain a coarse matrix, wherein the highest peak is determined based on the coarse matrix.

6. The method of claim 1, further comprising executing the search a plurality of times to obtain the angle of arrival or angle of departure.

7. The method of claim 1, further comprising executing a second pre-search after executing the coarse pre-search and before executing the search, wherein the second pre-search uses a higher resolution than the coarse pre-search and is performed over a third range, less than the first range and greater than the second range.

8. The method of claim 1, wherein the angle of arrival or angle of departure is used to perform wayfinding.

9. The method of claim 1, wherein the angle of arrival or angle of departure is used to perform spatial positioning.

10. A locator device, comprising:
an antenna array, arranged as a one- or two-dimensional array;
a wireless receiver in communication with the antenna array;
a processing unit; and
a memory device in communication with the processing unit, comprising instructions, which when executed by the processing unit, enable the locator device to:
execute a coarse pre-search, which comprises performing an angle of arrival or angle of departure algorithm at a low resolution, over a first range of azimuth and elevation angles to create a coarse matrix;
identify a highest peak from the coarse matrix;
execute a search, which comprises performing the angle of arrival or angle of departure algorithm at a high resolution over a scan region selected based on the highest peak, to create a result matrix, where the scan region is defined by a second range of azimuth and elevation angles, wherein the second range is smaller than the first range; and
determine the angle of arrival or angle of departure based on the result matrix.

11. The locator device of claim 10, wherein the memory device further comprises instructions, which when executed by the processing unit, enable the locator device to:
execute the coarse pre-search a plurality of times to obtain the coarse matrix.

12. The locator device of claim 10, wherein the memory device further comprises instructions, which when executed by the processing unit, enable the locator device to:
execute the search a plurality of times to obtain the result matrix.

13. The locator device of claim 10, wherein the memory device further comprises instructions, which when executed by the processing unit, enable the locator device to:
execute a second pre-search after executing the coarse pre-search and before executing the search, wherein the second pre-search uses a higher resolution than the coarse pre-search and is performed over a third range, less than the first range and greater than the second range.

14. The locator device of claim 10, wherein the low resolution is 5° or more.

15. The locator device of claim 10, wherein an amount of memory required to store the coarse matrix and the result matrix is less than 10 kB.

16. A device, comprising:
an antenna;
a wireless receiver in communication with the antenna;
a processing unit; and
a memory device in communication with the processing unit, comprising instructions, which when executed by the processing unit, enable the device to:
execute a coarse pre-search, which comprises performing an angle of arrival or angle of departure algorithm at a low resolution, over a first range of azimuth and elevation angles to create a coarse matrix;
identify a highest peak from the coarse matrix;
execute a search, which comprises performing the angle of arrival or angle of departure algorithm at a high resolution over a scan region selected based on the highest peak, to create a result matrix, where the scan region is defined by a second range of azimuth and elevation angles, wherein the second range is smaller than the first range; and
determine the angle of arrival or angle of departure based on the result matrix.

17. The device of claim 16, further comprising an indicator to inform an operator of the angle of departure.

18. The device of claim 16, further comprising an indicator to inform an operator of its spatial position.

19. The device of claim 16, wherein the low resolution is 5° or more.
